(19) United States
(12) Patent Application Publication
(10) Pub. No.: US 2026/0280081 A1
(43) Pub. Date: Sep. 17, 2026

(54) ELECTRODE ASSEMBLY AND RECHARGEABLE BATTERY INCLUDING THE SAME

(71) Applicant: SAMSUNG SDI CO., LTD., Yongin-si (KR)

(72) Inventor: Yu Jin KIM, Suwon-si (KR)

(73) Assignee: SAMSUNG SDI CO., LTD., Yongin-si (KR)

(21) Appl. No.: 19/390,783

(22) Filed: Nov. 17, 2025

(30) Foreign Application Priority Data
Feb. 5, 2025 (KR) 10-2025-0014176

(51) Int. Cl. H01M 50/586; H01M 10/0587; H01M 50/595

(52) U.S. Cl. CPC H01M 50/586; H01M 10/0587; H01M 50/595

(57) ABSTRACT

An electrode assembly and a battery including the same are disclosed. The electrode assembly includes a first electrode plate, a second electrode plate, and a separator interposed between the first electrode plate and the second electrode plate. An overhang portion of the separator relative to the first electrode plate and the second electrode plate is folded in a plurality of layers in a thickness direction of the separator.

### CROSS-REFERENCE TO RELATED APPLICATION

The present application claims priority to Korean Patent Application No. 10-2025-0014176, filed on Feb. 5, 2025 in the Korean Intellectual Property Office, the entire disclosure of which is incorporated herein by reference.

### BACKGROUND

### Technical Field

The present disclosure relates to an electrode assembly, and to a battery including the electrode assembly.

### Description of the Related Art

Unlike a primary battery that typically cannot be recharged, a rechargeable battery is a battery that can be recharged and discharged. A low-capacity rechargeable battery (hereinafter, referred to as a “battery”) is used for portable small-sized electronic devices such as, e.g., smartphones, feature phones, notebook computers, digital cameras, and camcorders, and a high-capacity battery is typically widely used as a power source for driving a motor in, e.g., hybrid vehicles, electric vehicles, or the like and as a battery for power storage. Such a battery includes electrodes including a positive electrode and/or a negative electrode, an electrode assembly including the electrodes, a case accommodating the electrode assembly, electrode terminals connected to the electrode assembly, and the like.

With the advancement of technology, there is an increasing demand for batteries with higher capacity. Accordingly, a plurality of batteries may be electrically connected and used. For example, a battery may be applied to an electronic device in the form of a battery module including a plurality of batteries, and/or a battery pack including a plurality of battery modules. According to an example embodiment, the battery pack is also configured with a plurality of batteries. In this case, the electronic device is an electronic device that requires high power and/or high capacity and includes, for example, an electric vehicle or the like.

An electrode assembly basically has a configuration in which a separator is interposed between a positive electrode plate and a negative electrode plate. However, unlike the positive or negative electrode plate that includes a metal substrate, the separator, which is formed of or includes a polymer or the like, is prone to shrinkage in high-temperature environments. In consideration of this, the separator typically has an overhang portion that is larger than the positive or negative electrode plate. The overhang portion typically has a length of, for example, about 1.5±0.06 mm. Accordingly, even when the separator undergoes a certain degree of shrinkage, the positive and negative electrode plates are hindered or prevented from coming into contact with each other and causing a short circuit.

However, when a battery is heated for evaluation, or is exposed to high-temperature environments for an extended period of time under certain usage conditions, the amount of shrinkage of the separator may increase, which may cause the positive and negative electrodes to come into physical contact with each other, which may result in a short circuit inside the battery. In particular, in a battery structure in which one of the positive and negative electrodes is larger than the other one, separator shrinkage increases the likelihood of a short circuit.

The above-described information disclosed in the background technology of the present disclosure is merely intended to improve understanding of the background of the present disclosure and thus may include information that does not form the related art.

### SUMMARY

Examples of the present disclosure include an electrode assembly and a battery including the electrode assembly, the electrode assembly being capable of hindering or preventing a short circuit even when exposed to high-temperature environments for an extended period of time.

The issues addressed by the examples of the present disclosure are not limited to the above-mentioned issues, and other issues not mentioned can be clearly understood by those skilled in the art from the following description.

According to an aspect of the present disclosure, an electrode assembly includes a first electrode plate, a second electrode plate, and a separator interposed between the first electrode plate and the second electrode plate. An overhang portion of the separator relative to the first electrode plate and the second electrode plate is folded in a plurality of layers in a thickness direction of the separator.

According to an aspect of the example embodiment, the overhang portion may include a rolling portion in which the separator is rolled into a circular shape.

In an example, in the rolling portion, the separator may be rolled multiple times around a winding core.

In an example, the electrode assembly may be or include a winding-type electrode assembly in which a stack of the first electrode plate, the separator, the second electrode plate, and the separator is wound multiple times, an electrode tab of each of the first electrode plate and the second electrode plate may be located on one side of the winding-type electrode assembly in a width direction, and the rolling portion may be located on the other side of the winding-type electrode assembly in the width direction.

In an example, in the rolling portion, the plurality of separators may be rolled together into a circular shape.

In an example, in the rolling portion, each of, or at least one of, the plurality of separators may be rolled into a circular shape.

According to another aspect of the example embodiment, the electrode assembly may be or include a stack-type electrode assembly in which a plurality of stacks, each including the first electrode plate, the separator, the second electrode plate, and the separator, all having a rectangular shape, are stacked, an electrode tab of each of the first electrode plate and the second electrode plate may be located on a first side of the rectangular shape, and the rolling portion may be located on a second side of the rectangular shape, which is opposite to the first side.

In an example, in the rolling portion, the plurality of separators may be rolled together into a circular shape.

In an example, in the rolling portion, each of the plurality of separators may be rolled into a circular shape.

According to still another aspect of the example embodiment, the overhang portion may have a length in a range of about 5 mm to about 7 mm, and the rolling portion may have a length in a range of about 1.0 mm to about 2.0 mm.

According to yet another aspect of the example embodiment, the electrode assembly may further include a finishing tape covering the overhang portion and having both end portions respectively attached to the outermost separators.

According to another aspect of the present disclosure, a battery includes an electrode assembly, and a case accommodating the electrode assembly therein. The electrode assembly includes a first electrode plate, a second electrode plate, and a separator interposed between the first electrode plate and the second electrode plate. An overhang portion of the separator relative to the first electrode plate and the second electrode plate is folded in a plurality of layers in a thickness direction of the separator.

### BRIEF DESCRIPTION OF THE DRAWINGS

The following drawings appended to the present specification are intended to illustrate example embodiments of the present disclosure, and the spirit of the present disclosure is more clearly understood from the accompanying drawings together with the following description of the example embodiments, and thus illustrations in the drawings should not be construed as limiting the scope of the present disclosure, in which:

FIG. 1 is a perspective view schematically illustrating an example of a battery according to one example embodiment;

FIG. 2 is a perspective view schematically illustrating another example of the battery according to one example embodiment;

FIG. 3 is a plan view schematically illustrating an example of a configuration of a winding-type electrode assembly of FIG. 1;

FIG. 4 is a plan view schematically illustrating an example of a configuration of a stack-type electrode assembly of FIG. 2;

FIG. 5 illustrates an example of a cross-sectional view taken along line V-V of FIG. 3 or 4, showing a case in which a first overhang portion of the separator is in a flat state;

FIG. 6 illustrates an example of a case in which a portion of the first overhang portion shown in FIG. 5 is rolled into a circular shape to form a rolling portion; and

FIG. 7 illustrates another example of the case in which a portion of the first overhang portion shown in FIG. 5 is rolled into a circular shape to form a rolling portion.

### DETAILED DESCRIPTION

Hereinafter, example embodiments of the present disclosure are described in detail with reference to the accompanying drawings. The terms or words used in the present specification and claims should not be construed as being limited to ordinary or dictionary meaning, and should be construed as meaning and concepts consistent with the technical spirit of the present disclosure based on the principle that an inventor can define concepts and terms as desired to explain the disclosure of the inventor in the best way. Therefore, the example embodiments described herein and the configuration illustrated in the drawings are only example embodiments and are not representative of the full the technical spirit of the present disclosure, and thus, it should be understood that various equivalents and modifications may be made at the time of filing the present application.

Further, when used in the present specification, “comprise/include” and/or “comprising/including” may specify the presence of described shapes, numbers, steps, operations, members, elements, and/or groups thereof and may not exclude the presence or addition of one or more other shapes, numbers, steps, operations, members, elements, and/or groups thereof.

Further, for helping understand the disclosure, the accompanying drawings may be illustrated not as actual scales. Rather, sizes of some components may be exaggerated. In addition, the same reference numerals may be assigned to the same components in different example embodiments.

The description that two objects for comparison are “the same” as each other may denote that they are “substantially the same” as each other. Thus, the range of the expression “substantially the same” may include a case of having a deviation considered as a low degree, for example, a deviation within 5%. In addition, the description that a certain parameter is the same in a certain region may denote that the parameter is the same from an average perspective.

Terms such as “first” and “second” may be used to describe various components, but the components are not limited by the terms. These terms are merely used to distinguish one component from another. Unless particularly described as the opposite, a “first” component may also be a “second” component.

Throughout the specification, unless particularly described otherwise, each component may be provided in a singular number or a multiple number.

Arrangement of any configuration on an “upper portion (or lower portion)” of a component or “on (or below)” the component may mean not only any configuration may be disposed to be in contact with an upper surface (or lower surface) of the component, but also that another configuration may be interposed between the component and any configuration disposed on (or below) the component.

In addition, when it is described that a component is “connected,” “coupled,” or “accessed” to another component, these components may be directly connected or accessed to each other, but it should be understood that still another component may be “interposed” between these components, or these components are “connected”, “coupled” or “accessed” through still another component.

As used herein, the term “and/or” includes any and all combinations of one or more of the associated listed items. Further, when describing example embodiments of the present disclosure, the use of “may” means one or more example embodiments of the present disclosure. When preceding a list of elements, the terms “one or more” and “at least one” modify the entire list of elements and do not modify the individual elements of the list.

The expression “A and/or B” throughout the specification means A, B, or A and B, unless otherwise differently stated. The expression “C to D” means C or more and D or less, unless otherwise specified.

When phrases such as “at least one of A, B and C, “at least one of A, B or C,” are used to designate a list of elements A, B and C, the phrase may refer to any and all suitable combinations or a subset of A, B and C, such as A, B, C, A and B, A and C, B and C, or A and B and C, in addition to other possible elements.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is understood that, although the terms “first,” “second,” “third,” and the like may be used herein to describe various elements, components, regions, layers, and/or sections, these elements, components, regions, layers, and/or sections should not be limited by these terms. These terms are used to distinguish one element, component, region, drawing layer, or cross section from another element, component, region, drawing layer, or cross section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the drawings. It is understood that the spatially relative terms are intended to encompass different orientations of the device in use or operation in addition to the orientation depicted in the figures. For example, when the device in the drawing is turned over, elements described as “below” or “beneath” other elements would then be oriented “above” or “over” the other elements. Thus, the term “below” may encompass both an orientation of above and below.

The terms used in the present specification are intended to describe example embodiments of the present disclosure and are not intended to limit the present disclosure.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

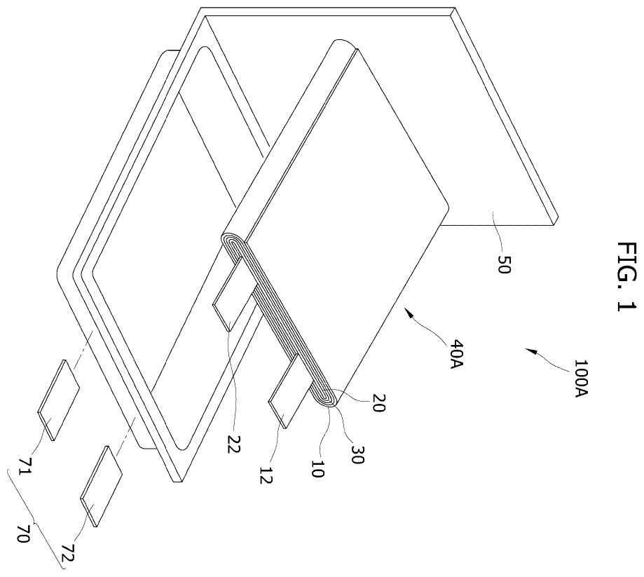

FIG. 1 is a perspective view schematically illustrating an example of a battery according to one example embodiment. Referring to FIG. 1, a battery 100A may include an electrode assembly 40A including a separator 30 interposed between a positive electrode plate (first electrode plate) 10 and a negative electrode plate (second electrode plate) 20, and a case 50 in which the electrode assembly 40A is accommodated.

The battery 100A of FIG. 1 corresponds to an example of a battery including a winding-type electrode assembly 40A. The winding-type electrode assembly 40A may have a structure in which a stack of the positive electrode plate 10/separator 30/negative electrode plate 20/separator 30, each of which has a relatively long sheet shape, is wound multiple times around two axes extending in a width direction and spaced apart from each other in a length direction.

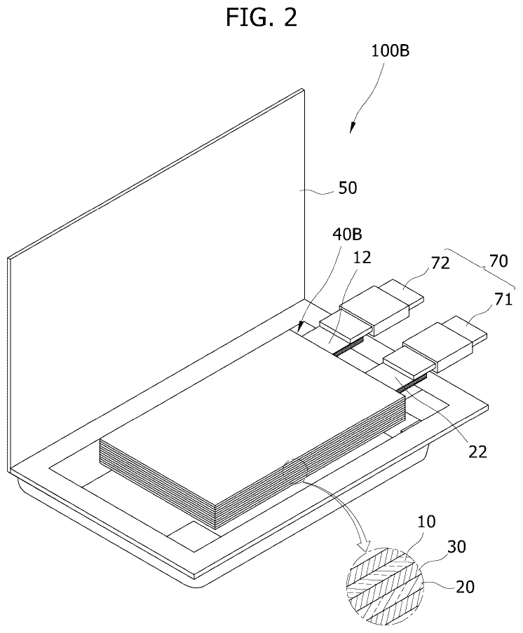

FIG. 2 is a perspective view schematically illustrating another example of the battery according to one example embodiment. Referring to FIG. 2, a battery 100B may include an electrode assembly 40B including a separator 30 interposed between a positive electrode plate (first electrode plate) 10 and a negative electrode plate (second electrode plate) 20, and a case 50 in which the electrode assembly 40B is accommodated.

The battery 100B of FIG. 2 corresponds to an example of a battery including a stack-type electrode assembly 40B. The stack-type electrode assembly 40B may have a structure in which a stack of the positive electrode plate 10/separator 30/negative electrode plate 20/separator 30, each of which has a rectangular shape, is stacked multiple times.

In addition, the battery 100A or 100B may include electrode tabs 70, i.e., a positive electrode tab 71 and a negative electrode tab 72, which constitute electrical paths for inducing a current generated in the electrode assembly 40A or 40B to the outside of the battery 100A or 100B. The positive electrode tab 71 and the negative electrode tab 72 may be disposed in the same direction with respect to the electrode assembly 40B, or may be disposed in different directions. In this case, the positive electrode tab 71 and the negative electrode tab 72 may be directly connected to substrate tabs 12 and 22 of the positive electrode plate 10 and the negative electrode plate 20, respectively, or may be electrically connected to the substrate tabs 12 and 22 through lead tabs (not shown).

Although not shown in FIG. 1 and FIG. 2, when viewed in a plan view, the separator 30 may have a relatively larger size than the positive electrode plate 10 and the negative electrode plate 20. For example, when viewed in a plan view, sizes of the positive electrode plate 10, the negative electrode plate 20, and the separator 30 may increase in this order. Accordingly, the separator 30 may prevent the positive electrode plate 10 and the negative electrode plate 20 from coming into direct physical contact with each other.

Hereinafter, when viewed in a plan view, the portion of the separator 30, excluding the portion overlapping with the electrode plate having a relatively larger size among the positive electrode plate 10 and the negative electrode plate 20, is referred to as an “overhang portion” of the separator 30 with respect to the positive electrode plate 10 and the negative electrode plate 20. In the case of the winding-type electrode assembly 40A, the overhang portion may be present on both upper and lower sides of the stack in the width direction. On the other hand, in the case of the stack-type electrode assembly 40B, the overhang portion may be present in four directions-upper, lower, left, and right-of the rectangular stack.

The positive electrode plate 10 may include a current collector (substrate) and a positive electrode active material layer formed on the current collector. Aluminum (Al) may be used as the current collector, but the present disclosure is not limited thereto. In addition, the positive electrode active material layer includes a positive electrode active material, and may further include a binder and/or a conductive material. A content of the positive electrode active material may range from about 90 wt % to about 99.5 wt % based on 100 wt % of the positive electrode active material layer, and a content of each of the binder and/or the conductive material may range from about 0.5 wt % to about 5 wt % based on 100 wt % of the positive electrode active material layer. In addition, the positive electrode plate 10 may further include an additive that can constitute a sacrificial positive electrode.

As the positive electrode active material, a compound (lithiated intercalation compound) that is capable of reversible intercalation and deintercalation of lithium may be used. For example, one or more of a composite oxide of lithium and a metal such as or including at least one of cobalt, manganese, nickel, and a combination thereof, may be used.

The composite oxide may be or include a lithium-transition metal composite oxide, and examples thereof may include at least one of lithium nickel-based oxide, lithium cobalt-based oxide, lithium manganese-based oxide, lithium iron phosphate-based compound, cobalt-free nickel-manganese-based oxide, or a combination thereof.

As an example, compounds represented by any one of the following chemical formulas may be used. LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); and LiₐFePO₄(0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare-earth element or a combination thereof; D is or includes at least one of O, F, S, P, or a combination thereof; G is or includes at least one of Al, Cr, Mn, Fe, Mg, La, Ce, Sr, V, or a combination thereof; and L1 is or includes at least one of Mn, Al, or a combination thereof.

As an example, the positive electrode active material may be or include a high-nickel-based positive electrode active material having a nickel content that is greater than or equal to 80 mol %, greater than or equal to 85 mol %, greater than or equal to 90 mol %, greater than or equal to 91 mol %, or greater than or equal to 94 mol % and less than or equal to 99 mol % based on 100 mol % of the metal excluding lithium in the lithium-transition metal composite oxide. The high-nickel-based positive electrode active material may be capable of realizing high capacity, and can be applied to high-capacity and high-density rechargeable batteries.

The binder adheres positive electrode active material particles to each other, and adheres the positive electrode active material to the current collector. Representative examples of the binder include at least one of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, or the like, but the present disclosure is not limited thereto.

The conductive material may impart conductivity to the electrode, and any material that does not cause a chemical change and that is electrically conductive may be used in the configured battery. Examples of the conductive material may include a carbon-based material such as at least one of natural graphite, artificial graphite, carbon black, acetylene black, Ketjen black, carbon fibers, carbon nanofibers, or carbon nanotubes; a metal-based material in the form of a metal powder or metal fiber including at least one of copper, nickel, aluminum, silver, or the like; a conductive polymer such as a polyphenylene derivative; or a mixture thereof.

The negative electrode plate 20 includes a current collector (substrate) and a negative electrode active material layer located on the current collector. The negative electrode current collector may be or include at least one of a copper foil, a nickel foil, a stainless steel foil, a titanium foil, a nickel foam, a copper foam, a polymer substrate coated with a conductive metal, and a combination thereof.

In addition, the negative electrode active material layer includes a negative electrode active material, and may further include a binder and/or a conductive material. For example, the negative electrode active material layer may include about 90 wt % to about 99 wt % of the negative electrode active material, about 0.5 wt % to about 5 wt % of the binder, and about 0 wt % to about 5 wt % of the conductive material.

The negative electrode active material includes at least one of a material that can reversibly intercalate/deintercalate lithium ions, a lithium metal, a lithium metal alloy, a material capable of doping and dedoping lithium, or a transition metal oxide.

The material capable of reversible intercalation and deintercalation of lithium ions is a carbon-based negative electrode active material, and may include, for example, crystalline carbon, amorphous carbon, or a combination thereof. Examples of the crystalline carbon may include graphite such as amorphous, plate shape, flake, spherical shape or fibrous natural graphite or artificial graphite. Examples of the amorphous carbon may include at least one of soft carbon, hard carbon, a mesophase pitch carbonized product, calcined coke, and the like.

The lithium metal alloy may be or include an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

A Si-based negative electrode active material or a Sn-based negative electrode active material may be included as the material capable of doping and dedoping lithium. The Si-based negative electrode active material may include at least one of silicon, a silicon-carbon composite, SiOx (0<x<2), a Si-Q alloy (where, Q is or includes at least one of an alkali metal, an alkaline-earth metal, a Group 13 element, a Group 14 element (excluding Si), a Group 15 element, a Group 16 element, a transition metal, a rare-earth element, and a combination thereof), or a combination thereof. The Sn-based negative electrode active material may be or include at least one of Sn, SnO2, a Sn-based alloy, or a combination thereof.

The silicon-carbon composite may be or include a composite of silicon and amorphous carbon. According to one example embodiment, the silicon-carbon composite may be in the form of silicon particles, and amorphous carbon coated on the surface of the silicon particles. For example, the silicon-carbon composite may include a secondary particle (core) in which silicon primary particles are agglomerated, and an amorphous carbon coating layer (shell) located on the surface of the secondary particle. The amorphous carbon may also be located between the silicon primary particles, such that, for example, the silicon primary particles are coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer located on the surface of the core.

The Si-based negative electrode active material or the Sn-based negative electrode active material may be mixed with a carbon-based negative electrode active material.

The binder adheres negative electrode active material particles to each other, and adheres the negative electrode active material to the current collector. A non-aqueous binder, an aqueous binder, a dry binder, or a combination thereof may be used as the binder.

The non-aqueous binder may include at least one of polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, fluororubber, a polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, and a combination thereof.

When the aqueous binder is used as the negative electrode binder, a cellulose-based compound capable of imparting viscosity can be further included. As the cellulose-based compound, one or more of carboxymethyl cellulose, hydroxypropylmethyl cellulose, methyl cellulose, or alkali metal salts thereof may be used in combination. At least one of Na, K, or Li can be used as the alkali metal.

The dry binder is or includes a polymer material capable of being fiberized, and may be or include, for example, at least one of polytetrafluoroethylene, polyvinylidene fluoride, a polyvinylidene fluoride-hexafluoropropylene copolymer, a polyethylene oxide, or a combination thereof.

The conductive material may impart conductivity to the electrode, and any material that does not cause a chemical change, and that is electrically conductive, may be used in the configured battery. Examples of the conductive material may include a carbon-based material such as or including at least one of natural graphite, artificial graphite, carbon black, acetylene black, Ketjen black, carbon fibers, or carbon nanofibers; a metal-based material in the form of a metal powder or metal fiber including at least one of copper, nickel, aluminum, silver, or the like; a conductive polymer such as a polyphenylene derivative; or a mixture thereof.

The electrolyte includes a non-aqueous organic solvent and a lithium salt.

The non-aqueous organic solvent constitutes a medium through which ions taking part in the electrochemical reaction of a battery can move. The non-aqueous organic solvent may be or include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), ethylmethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvent may include ethyl alcohol, isopropyl alcohol, and the like. The aprotic solvent may include at least one of nitriles such as R—CN (where R is a C2 to C20 linear, branched, or cyclic hydrocarbon group and includes a double bond, an aromatic ring, or an ether bond), and the like; amides such as dimethyl formamide; dioxolanes such as 1,3-dioxolane and 1,4-dioxolane; sulfolanes; and the like.

The non-aqueous organic solvents may be used alone or in combination of two or more solvents.

In addition, when the carbonate-based solvent is used, a cyclic carbonate and a chain carbonate may be mixed, and the cyclic carbonate and the chain carbonate may be mixed in a volume ratio in a range of about 1:1 to about 1:9.

The lithium salt dissolves in the organic solvent and constitutes a source of lithium ions in a battery, enables an operation of a rechargeable battery, and prompts the movement of the lithium ions between positive and negative electrodes. Representative examples of the lithium salt may include at least one of, or two or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂) (C_{y}F_{2y+1}SO₂) (where, x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The separator 30 may be made of or include at least one of polyethylene, polypropylene, polyvinylidene fluoride, or a multilayer film of two or more layers thereof, and may, of course, also be made of or include a mixed multilayer film, such as at least one of a polyethylene/polypropylene double-layered separator, a polyethylene/polypropylene/polyethylene three-layered separator, and a polypropylene/polyethylene/polypropylene three-layered separator.

The separator 30 may include a porous substrate, and a coating layer including an organic material, an inorganic material, or a combination thereof located on one surface, or on both surfaces, of the porous substrate.

The porous substrate may be a polymer film formed of or including a polymer, or a copolymer, or a mixture of at least two or more of polyolefins such as polyethylene, polypropylene, and the like, polyesters such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, a polyphenylene oxide, a cyclic olefin copolymer, polyphenylene sulfide, polyethylene naphthalate, glass fibers, Teflon, and polytetrafluoroethylene.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic and inorganic materials may be mixed in one coating layer, or may be present in a form in which a coating layer including organic materials and a coating layer including inorganic materials are stacked together.

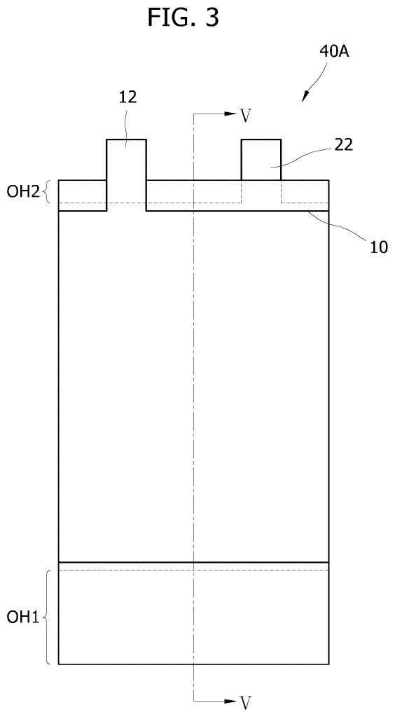

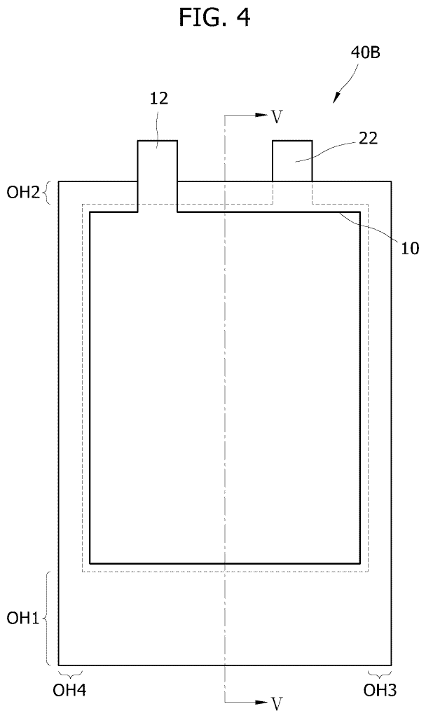

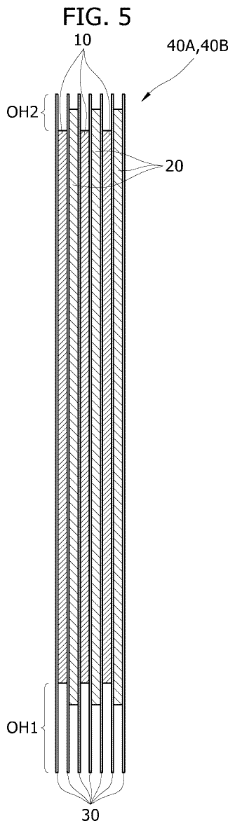

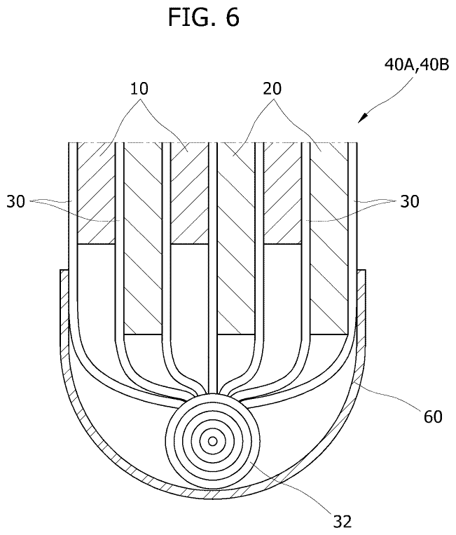

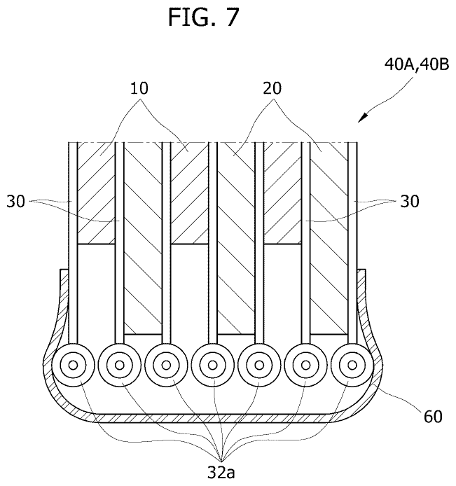

FIG. 3 is a plan view schematically illustrating an example of a configuration of the winding-type electrode assembly of FIG. 1. FIG. 4 is a plan view schematically illustrating an example of a configuration of the stack-type electrode assembly of FIG. 2. FIG. 5 is a cross-sectional view taken along line V-V of FIG. 3 or FIG. 4, illustrating a case in which a first overhang portion of the separator is in a flat state. FIG. 6 illustrates an example of a case in which a portion of the first overhang portion shown in FIG. 5 is rolled into a circular shape to form a rolling portion. FIG. 7 illustrates another example of the case in which a portion of the first overhang portion shown in FIG. 5 is rolled into a circular shape to form a rolling portion.

In FIG. 5 to FIG. 7, the winding-type electrode assembly 40A, or the stack-type electrode assembly 40B, is illustrated as including a stack of three positive electrode plates 10, three negative electrode plates 20, and seven separators 30 in a thickness direction, but this is merely illustrative. The winding-type electrode assembly 40A or the stack-type electrode assembly 40B may have a configuration in which a greater number of positive electrode plates 10, negative electrode plates 20, and separators 30 are stacked in the thickness direction than those illustrated in FIG. 5 to FIG. 7.

In addition, in FIG. 5 to FIG. 7, each of the components of the electrode assembly 40A or 40B, particularly the positive electrode plate 10 and the negative electrode plate 20, is illustrated as a single member having a predetermined or desired thickness. However, this configuration is merely a simplified illustration to more clearly depict the technical concept of the example embodiments. Actual cross-sectional shapes of the positive electrode plate 10 and the negative electrode plate 20 may be different from the cross-sectional shapes shown in the drawings. For example, the positive electrode plate 10 and the negative electrode plate 20 may each have an active material layer of a predetermined or desired thickness formed on one surface, or on both surfaces, of a substrate, such as, e.g., a thin foil. At this time, when viewed in a plan view, the active material layer may be formed only on a partial region of the substrate. In addition, the position, area, and the like, of the region in which the active material layer is formed may vary depending on the type of battery and/or electrode.

Referring to FIG. 3 to FIG. 7, each of the electrode assemblies 40A and 40B includes the positive electrode plate (first electrode plate) 10, the separator 30, the negative electrode plate (second electrode plate) 20, and the separator 30. The positive electrode plate 10 and the negative electrode plate 20 may include a positive electrode substrate tab 12 and a negative electrode substrate tab 22, respectively. As shown in FIG. 3 to FIG. 7, the positive electrode substrate tab 12 and the negative electrode substrate tab 22 may be located in the same direction with reference to the electrode assembly 40A or 40B, but the present disclosure is not limited thereto. For example, the positive electrode substrate tab 12 and the negative electrode substrate tab 22 may be located in opposing locations with respect to the electrode assembly 40A. In addition, although not shown in the drawings, each of, or at least one of, the electrode assemblies 40A and 40B may further include a positive electrode tab and a negative electrode tab respectively joined to the positive substrate tab 12 of the positive electrode plate 10 and the negative substrate tab 22 of the negative electrode plate 20 (see FIG. 1).

In the winding-type electrode assembly 40A, each of the positive electrode plate 10, the negative electrode plate 20, and the separator 30 may have a rectangular shape with a difference, e.g., a significant difference, in size between a long side and a short side. In this case, the size, i.e., a length, of the long side of each of the positive electrode plate 10, the negative electrode plate 20, and the separator 30 (hereinafter, a direction parallel to the long side of each of the positive electrode plate 10, the negative electrode plate 20, or the separator 30, is referred to as the “length” direction) is not particularly limited and may be selected as desired in consideration of the type, performance, or the like of a battery including the electrode assembly 40A. In addition, the size, i.e., a width, of the short side of each of the positive electrode plate 10, the negative electrode plate 20, and the separator 30 (hereinafter, a direction parallel to the short side of each of the positive electrode plate 10, the negative electrode plate 20, and the separator 30, which is also parallel to a winding axis, is referred herein to as the “width” direction) is not particularly limited and may be selected as desired in consideration of the type, performance, or the like of a battery including the electrode assembly 40A.

The winding-type electrode assembly 40A may have a jelly-roll shape in which a stack, in which the positive electrode plate 10, the separator 30, the negative electrode plate 20, and the separator 30 are stacked, e.g., sequentially stacked, is wound multiple times in the length direction. In addition, the winding-type electrode assembly 40A may have an overall elliptical shape when viewed in the width direction, (i.e., from the upper side or the lower side in FIG. 3). That is, the winding-type electrode assembly 40A may have a shape in which the stack is wound around a pair of winding axes, which are parallel to the width direction and spaced apart from each other by a predetermined or desired distance.

In the case of the winding-type electrode assembly 40A illustrated in FIG. 3, the positive electrode plate 10, the negative electrode plate 20, and the separator 30 may each have a different width. For example, the width of the positive electrode plate 10 may be the smallest, and the width of the separator 30 may be the largest. Typically, the width of the separator 30 is larger than the widths of the positive electrode plate 10 and the negative electrode plate 20, so that the separator 30 has overhang portions OH1 and OH2 in the width direction (see FIG. 3). Accordingly, even when the separator 30 partially shrinks, physical contact between the positive electrode plate 10 and the negative electrode plate 20 can be reduced or prevented.

In the stack-type electrode assembly 40B illustrated in FIG. 4, each of the positive electrode plate 10, the negative electrode plate 20, and the separator 30 may have a substantially rectangular shape, which may be either oblong or square. At this time, the size of each of the positive electrode plate 10, the negative electrode plate 20, and the separator 30, i.e., the length (the size in a horizontal direction) and the width (the size in a vertical direction), is not particularly limited, and may be selected as desired in consideration of the type or performance of the battery including the electrode assembly 40B. The stack-type electrode assembly 40B may have a configuration in which a stack of the positive electrode plate 10, the separator 30, the negative electrode plate 20, and the separator 30 is stacked multiple times.

In the case of the stack-type electrode assembly 40B, each of the positive electrode plate 10, the negative electrode plate 20, and the separator 30 may have a different length and a different width. For example, the length and width of the positive electrode plate 10 may be the smallest, and the length and width of the separator 30 may be the largest. Typically, the length and width of the separator 30 are larger than the length and width of the positive electrode plate 10 and the negative electrode plate 20, so that the separator 30 has the overhang portions OH1 and OH2 in the width direction and overhang portions OH3 and OH4 in the length direction (see FIG. 4). Accordingly, even when the separator 30 partially shrinks, physical contact between the positive electrode plate 10 and the negative electrode plate 20 can be reduced or prevented.

In the case of conventional electrode assemblies, the size of the overhang portion in the width direction of the electrode assembly 40A or 40B is approximately 1.5±0.06 mm. In this case, when the degree of shrinkage of the separator 30 is not significant, physical contact between the positive electrode plate 10 and the negative electrode plate 20 may be prevented. However, when the battery is heated for thermal evaluation or is exposed to a high-temperature environment for an extended period of time under certain usage conditions, the amount of shrinkage of the separator 30 may increase, and the overhang portion may curl into a space between the positive electrode plate 10 and the negative electrode plate 20. As a result, the positive electrode plate 10 and the negative electrode plate 20 may come into physical contact with each other, which may cause a short circuit inside the battery.

According to the present example embodiment, the size of at least one of a first overhang portion OH1 located on a lower side and a second overhang portion OH2 located on an upper side in the width direction of the electrode assembly 40A or 40B is larger than the size of the overhang portions in the conventional electrode assembly. For example, as shown in FIG. 3 to FIG. 5, the size of the first overhang portion OH1 may be larger than the size of the first overhang portion OH1 in the conventional electrode assembly. However, the present disclosure is not limited thereto, and the size of the second overhang portion OH2 may be larger than the size of the second overhang portion OH2 in the conventional electrode assembly, or the sizes of both the first and second overhang portions OH1 and OH2 may be larger than the sizes of the first and second overhang portions OH1 and OH2 in the conventional electrode assembly. The first overhang portion OH1, which is formed by an increase in size in the width direction, may have a size in a range of, for example, about 4 mm to about 8 mm, and, for example, about 5 mm to about 7 mm.

In addition, according to the example embodiment, the first overhang portion OH1 of the separator 30 may be folded into multiple layers in the thickness direction of the separator 30 (see FIG. 6 and FIG. 7), rather than remaining flat as shown in FIG. 3 to FIG. 5. That is, the first overhang portion OH1 of the separator 30 may have a shape having a greater thickness than the remaining portion of the separator 30, e.g., the portion overlapping the positive electrode plate 10 and/or the negative electrode plate 20. Accordingly, even when the separator 30 shrinks under conditions such as high temperature, and the first overhang portion OH1 also shrinks accordingly, the first overhang portion OH1, which has a greater thickness than the other portion of the separator 30, e.g., the portion overlapping the positive electrode plate 10 and/or the negative electrode plate 20, may not curl into the space between the positive electrode plate 10 and the negative electrode plate 20.

One method for forming the first overhang portion OH1 in a plurality of folded layers is to roll the first overhang portion OH1 into a circular shape to form a rolling portion 32. For example, a portion of the first overhang portion OH1, for example, the portion corresponding to the increase in size compared to a conventional overhang portion (i.e., the portion corresponding to about 4.5 mm from the end, excluding the conventional overhang portion of about 1.5 mm when the size of the first overhang portion OH1 is about 6 mm), may be rolled into a circular shape to form the rolling portion 32. When the first overhang portion OH1 forms the rolling portion 32 as described above, even when the separator 30 shrinks under conditions such as high temperature, and the first overhang portion OH1 also shrinks accordingly, the rolling portion 32 may not curl into the space between the positive electrode plate 10 and the negative electrode plate 20.

As shown in FIG. 6, the rolling portion 32 may be formed by rolling all the first overhang portions OH1 of the separators 30 included in the electrode assembly 40A or 40B together into a circular shape. In this case, one rolling portion 32 may be formed in the electrode assembly 40A or 40B. Accordingly, since the first overhang portions OH1 of all the separators 30 are bundled together to form the rolling portion 32, even when the separator 30 shrinks under conditions such as high temperature and the first overhang portion OH1 also shrinks accordingly, the rolling portion 32 may not curl into the space between the positive electrode plate 10 and the negative electrode plate 20.

As another example, as shown in FIG. 7, rolling portions 32a may each be formed by individually rolling the first overhang portion OH1 of each separator 30 into a circular shape. In this case, the rolling portions 32a are formed in a number corresponding to the number of the separators 30. Even when the rolling portion 32a is formed by rolling only one separator 30 into a circular shape, the rolling portion 32a may have a greater size in the thickness direction than other portions of the separator 30, and thus, curling of the rolling portion 32a into the space between the positive electrode plate 10 and the negative electrode plate 20 during shrinkage of the separator 30 may be reduced or suppressed.

As another example, all the separators 30 included in the electrode assembly 40A or 40B may be grouped into a plurality of groups, and the first overhang portions OH1 of the separators 30 in each group may be bundled together and rolled into a circular shape to form the rolling portions. For example, the first overhang portions OH1 of two or more adjacent separators 30 may be rolled together into a circular shape to form the rolling portions. Accordingly, the number of rolling portions may be two or more, but less than the total number of separators 30.

As another example, the first overhang portions OH1 of one or a plurality of the separators 30 may be folded one or more times so that the first overhang portions OH1 overlap in a plurality of layers. In this case, when the first overhang portion OH1 is folded multiple times, a folding direction may alternate between inward and outward.

Continuing to refer to FIG. 6 and FIG. 7, the electrode assembly 40A or 40B may further include a finishing tape 60. The finishing tape 60 may cover the first overhang portion OH1 forming the rolling portion 32 or 32a, and to fix the rolling portion 32 or 32a in place so that the rolling portion 32 or 32a does not move, or substantially does not move. To this end, the finishing tape 60 may cover the rolling portion 32 or 32a, with both end portions thereof adhered to outer surfaces of the separators 30 located at the outermost edges. The type of the finishing tape 60 is not particularly limited, and the finishing tape 60 may be, e.g., formed of or include an electrically insulating polymer such as, e.g., polyimide.

According to an example embodiment of the present disclosure, a short circuit in a battery can be effectively hindered or prevented by ensuring that a separator does not curl into a space between a positive electrode plate and a negative electrode plate even when exposed to high-temperature environments for an extended period of time.

However, it is appreciated by persons skilled in the art that the effects that can be achieved through the present disclosure are not limited to what has been described hereinabove, and other advantages of the present disclosure are more clearly understood from the detailed description above.

While the above disclosure has been described with reference to the example embodiments illustrated in the accompanying drawings, it should be understood that the disclosure is not limited to the disclosed example embodiments, but is intended to cover various modifications and equivalent arrangements included within the sprit and scope of the appended claims.

Accordingly, the scope of the present disclosure shall be determined only according to the attached claims.

What is claimed is:

1. An electrode assembly comprising:
a first electrode plate;
a second electrode plate; and
a separator interposed between the first electrode plate and the second electrode plate,
wherein an overhang portion of the separator relative to the first electrode plate and the second electrode plate is folded in a plurality of layers in a thickness direction of the separator.

2. The electrode assembly of claim 1, wherein the overhang portion comprises a rolling portion in which the separator is rolled into a circular shape.

3. The electrode assembly of claim 2, wherein, in the rolling portion, the separator is rolled multiple times around a winding core.

4. The electrode assembly of claim 3, wherein:
the separator comprises a plurality of separators; and
the electrode assembly comprises a winding-type electrode assembly in which a stack of the first electrode plate, one of the plurality of separators, the second electrode plate, and another of the plurality of separators is wound multiple times,
an electrode tab of each of the first electrode plate and the second electrode plate is located on one side of the winding-type electrode assembly in a width direction, and
the rolling portion is located on the other side of the winding-type electrode assembly in the width direction.

5. The electrode assembly of claim 4, wherein, in the rolling portion, the plurality of separators are rolled together into a circular shape.

6. The electrode assembly of claim 4, wherein, in the rolling portion, at least one of the plurality of separators is rolled into a circular shape.

7. The electrode assembly of claim 3, wherein:
the separator comprises a plurality of separators; and
the electrode assembly comprises a stack-type electrode assembly in which a plurality of stacks, each including the first electrode plate, one of the plurality of separators, the second electrode plate, and another of the plurality of separators, all having a rectangular shape, are stacked,
an electrode tab of each of the first electrode plate and the second electrode plate is located on a first side of the rectangular shape, and
the rolling portion is located on a second side of the rectangular shape, which is opposite to the first side.

8. The electrode assembly of claim 7, wherein, in the rolling portion, the plurality of separators are rolled together into a circular shape.

9. The electrode assembly of claim 7, wherein, in the rolling portion, at least one of the plurality of separators is rolled into a circular shape.

10. The electrode assembly of claim 2, wherein:
the overhang portion has a length in a range of about 5 mm to about 7 mm, and
the rolling portion has a length in a range of about 1.0 mm to about 2.0 mm.

11. The electrode assembly of claim 1, wherein:
the separator comprises a plurality of separators; and
the electrode assembly further comprises a finishing tape covering the overhang portion and having both end portions respectively attached to outermost separators.

12. A battery comprising:
an electrode assembly; and
a case accommodating the electrode assembly therein,
wherein the electrode assembly includes a first electrode plate, a second electrode plate, and a separator interposed between the first electrode plate and the second electrode plate, and
an overhang portion of the separator relative to the first electrode plate and the second electrode plate is folded in a plurality of layers in a thickness direction of the separator.

13. The battery of claim 12, wherein the overhang portion comprises a rolling portion in which the separator is rolled into a circular shape around a winding core.

14. The battery of claim 13, wherein:
the separator comprises a plurality of separators; and
the electrode assembly comprises a winding-type electrode assembly in which a stack of the first electrode plate, one of the plurality of separators, the second electrode plate, and another of the plurality of separators is wound multiple times,
an electrode tab of each of the first electrode plate and the second electrode plate is located on one side of the winding-type electrode assembly in a width direction, and
the rolling portion is located on the other side of the winding-type electrode assembly in the width direction.

15. The battery of claim 14, wherein, in the rolling portion, the plurality of separators are rolled together into a circular shape.

16. The battery of claim 14, wherein, in the rolling portion, at least one of the plurality of separators is rolled into a circular shape.

17. The battery of claim 13, wherein:
the separator comprises a plurality of separators; and
the electrode assembly comprises a stack-type electrode assembly in which a plurality of stacks, each including the first electrode plate, one of the plurality of separators, the second electrode plate, and another of the plurality of separators, all having a rectangular shape, are stacked,
an electrode tab of each of the first electrode plate and the second electrode plate is located on a first side of the rectangular shape, and
the rolling portion is located on a second side of the rectangular shape, which is opposite to the first side.

18. The battery of claim 17, wherein, in the rolling portion, the plurality of separators are rolled together into a circular shape.

19. The battery of claim 17, wherein, in the rolling portion, at least one of the plurality of separators is rolled into a circular shape.

20. The battery of claim 12, wherein:
the separator comprises a plurality of separators; and
the electrode assembly further comprises a finishing tape covering the overhang portion and having both end portions respectively attached to outermost separators.
